(19) United States
(12) Patent Application Publication
(10) Pub. No.: US 2008/0127728 A1
(43) Pub. Date: Jun. 5, 2008

(54) MECHANICAL RESPONSE BASED DETONATION VELOCITY MEASUREMENT SYSTEM

(75) Inventors: Mark Felipe Baptista, Framingham, MA (US); Adam Rasheed, Glenville, NY (US); Anthony John Dean, Scotia, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company, Schenectady, NY (US)

(21) Appl. No.: 11/565,252

(22) Filed: Nov. 30, 2006

(51) Int. Cl. G01H 5/00

(52) U.S. Cl. 73/597

(57) ABSTRACT

A pulse detonation device contains a detonation chamber and a propagation portion, and a plurality of mechanical response gauges coupled to an exterior surface of at least one of the detonation chamber and the propagation portion. Signals from the mechanical response gauges are sent to high frequency AC-coupled amplifiers, and the amplified signals are sent to a high frequency data acquisition system. Based on the data from the mechanical response gauges, the velocity of a detonation pressure wave is determined.

### BACKGROUND OF THE INVENTION

This invention relates to pulse detonation systems, and more particularly, to mechanical response based detonation velocity measurement systems.

With the recent development and interest in pulse detonation combustors (PDCs) and engines (PDEs), various efforts have been underway to develop PDCs for use in practical applications, such as combustors for aircraft engines. It is necessary to monitor various parameters of the operation of PDCs. Such parameters include the pressures generated, temperatures reached and the rate at which a shock wave or pressure wave travels along the length of the device.

However, because of the nature the PDCs the monitoring of these parameters can be difficult. The pulse detonation process generates detonation waves which travel at very high speeds and generate very high pressures, and high temperatures. Because of these conditions, many conventional measurement and monitoring techniques have difficulty in accurately monitoring these conditions, among others. For example, when monitoring the pressures involved, or conducting pressure diagnostics, it is known to use high frequency pressure piezoelectric transducers or ion probes. However, both of these types of monitoring devices can operate effectively and accurately for only a short duration in high temperature, high pressure and high vibration conditions. Because of these drawbacks, these methods are less than desirable in the pulse detonation environment, where temperatures, pressures and vibrations are high. Therefore, there is a need for a system and method of monitoring various operational parameters of pulse detonation devices which is reliable and robust in such an environment.

### SUMMARY OF THE INVENTION

In an embodiment of the invention, a pulse detonation device is provided which is configured as typical pulse detonation devices. Namely, the device contains a combustion chamber and a propagation portion, downstream of the combustion chamber. The pulse detonation device also has at least one input portion to allow air flow to enter the chamber, at least one fuel input portion and at least one detonation ignition source. Additionally, the pulse detonation device of the present invention contains a plurality of mechanical response instruments such as dynamic strain gauges or accelerometers, or the like, which are positioned on an either an exterior surface of the combustion chamber or an exterior surface of the propagation portion, or both.

In an embodiment of the invention, the mechanical response gauges are coupled to high frequency AC-coupled amplifiers which transmit signals to a high speed data acquisition system. The high speed data acquisition system records the signals, and an analysis is conducted which allows for the detonation pressure wave speed to be calculated. Because the spacing of the mechanical response gauges is known, the velocity of pressure waves can be determined.

In another embodiment of the present invention, the mechanical response gauges are used in conjunction with high frequency pressure transducers and/or ion probes, to obtain further information.

As used herein, a “pulse detonation combustor” PDC (also including PDEs) is understood to mean any device or system that produces both a pressure rise and velocity increase from a series of repeating detonations or quasi-detonations within the device. A “quasi-detonation” is a supersonic turbulent combustion process that produces a pressure rise and velocity increase higher than the pressure rise and velocity increase produced by a deflagration wave. Embodiments of PDCs (and PDEs) include a means of igniting a fuel/oxidizer mixture, for example a fuel/air mixture, and a detonation chamber, in which pressure wave fronts initiated by the ignition process coalesce to produce a detonation wave. Each detonation or quasi-detonation is initiated either by external ignition, such as spark discharge or laser pulse, or by gas dynamic processes, such as shock focusing, auto ignition or by another detonation (i.e. cross-fire).

### BRIEF DESCRIPTION OF THE DRAWINGS

The advantages, nature and various additional features of the invention will appear more fully upon consideration of the illustrative embodiment of the invention which is schematically set forth in the figures, in which:

FIG. 1 shows a diagrammatical representation of an embodiment of the present invention employing dynamic strain gauges;

FIG. 2 shows a diagrammatical representation of a system of monitor and recording data in accordance with an embodiment of the present invention; and

FIG. 3 shows a diagrammatical representation of a cross-section of an embodiment of the present invention.

### DETAILED DESCRIPTION OF THE INVENTION

The present invention will be explained in further detail by making reference to the accompanying drawings, which do not limit the scope of the invention in any way.

It is noted, initially, that the present invention is not limited to the structure or configuration of the pulse detonation device in any way, as the present invention may be used on any structural configuration of a pulse detonation device. Therefore, the following discussion will discuss the pulse detonation device in general terms. Further, although the following discussion is directed to using the present invention when testing pulse detonation devices, the present invention is not limited in this regard, as the present invention may also be incorporated in any application, whether testing or in an operational capacity. The present invention, may be used in any application where the monitoring of the data is desired or required.

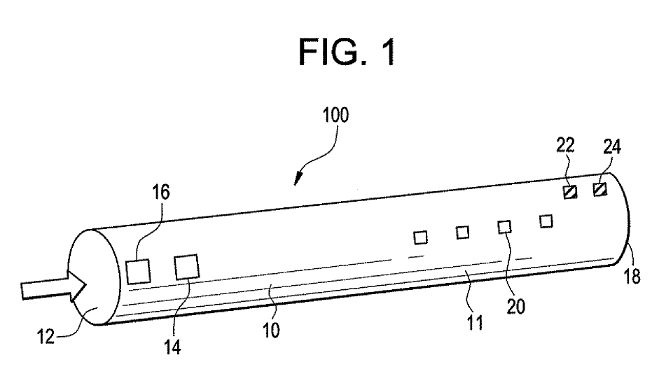

Turning now to FIG. 1, a pulse detonation device 100 is shown. the pulse detonation device 100 contains a detonation chamber 10, a propagation portion 1, an inlet portion 12 and an exit portion 18. The device 100 also contains at least one fuel injection device 16 and at least one ignition source 14. On an exterior surface of either the propagation portion 11 or the chamber 10, or both, are a plurality of mechanical response gauges 20.

The inlet portion 12 allows an air flow to enter the device 100 and the detonation chamber 10. The configuration of the inlet portion 12 can be of any known or used configuration. Further, the flow through the inlet portion 12 may be either air or a fuel-air mixture. The present invention is not limited in this regard. In an embodiment of the invention, fuel is mixed with the flow downstream of the inlet portion 12, as fuel is input into the device 100 through at least one fuel injection device 16. The fuel injection device 16 can be of any known configuration or structure, to provide fuel for the combustion.

Downstream of the at least one fuel injection device 16 is at least one ignition source 14. The ignition source 14 is used to ignite the fuel-air mixture within the chamber 10. The ignition source 14 may be any commonly known or used ignition sources for pulse detonation devices. Once the at least one ignition source 14 ignites the fuel-air mixture a detonation is created within the chamber 10. The detonation creates a high strength pressure wave which travels, at least in part, downstream through the device 100 and passes from the chamber 10 to the propagation portion 11 and continues downstream until it exits the device 100 through the exit portion 18.

Because the general operation of pulse detonation devices is known, a detailed discussion of their operation and the dynamics of the detonation process will not be discussed herein.

In the embodiment shown in FIG. 1 both the chamber 10 and propagation portion 11 are shown with a cylindrical shape. However, the present invention is not limited in this regard.

As shown in FIG. 1, in an embodiment of the present invention, a plurality of mechanical response gauges 20 are located on an exterior surface of the propagation portion 11 of the device 100. The mechanical response gauges 20 are located on the surface a set distance from each other, such that the distance between the gauges 20 are known. Because the distances are known, the velocity and/or acceleration or deceleration of a pressure wave can be determined.

The mechanical response gauges 20 are secured to the surface of the portion 11 in accordance with the specific requirements of the mechanical response gauges 20 used. In an embodiment of the present invention, the gauges 20 used are high frequency and high temperature dynamic strain gauges, which are capable of withstanding relatively high temperatures and provide signal at relatively high frequency rates. Further, the orientation of the gauges 20 is a function of the data to be collected or monitored. In an embodiment of the invention, the gauges 20 are oriented in the hoop direction. However, it is also contemplated that the gauges 20 be mounted in an angle to the hoop direction.

As shown in FIG. 1, four (4) gauges 20 are used, and are placed co-linearly along the device, However, the present invention is not limited in this regard. In another embodiment of the present invention, the number of the gauges 20, can be as few as two (2), three (3), or more than four (4). The number of gauges 20 used is dependent on the desired data to be recorded and captured. Moreover, the present invention is not limited to the spacing between the gauges 20. As shown in FIG. 1, the spacing between the gauges 20 is constant. The present invention is not limited to this configuration, as it is contemplated that the spacing may be changed as desired or required, and is a function of the data to be collected.

Further, within the present invention the mechanical response gauges may be of any known type. In an exemplary embodiment of the invention, the gauges 20 may be dynamic strain gauges. In a further embodiment, accelerometers, or the like, may be used. Additionally, it is contemplated that a combination of different types of mechanical response gauges 20 be used, depending on system operational and performance requirements.

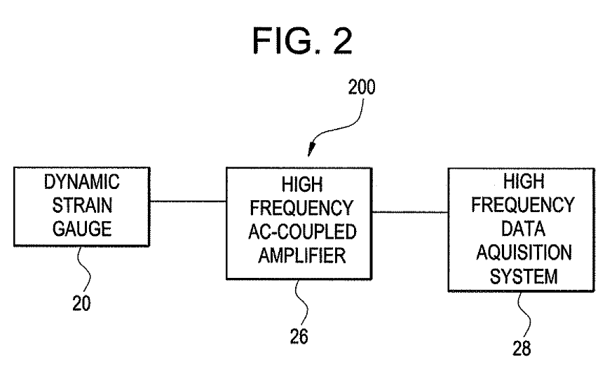

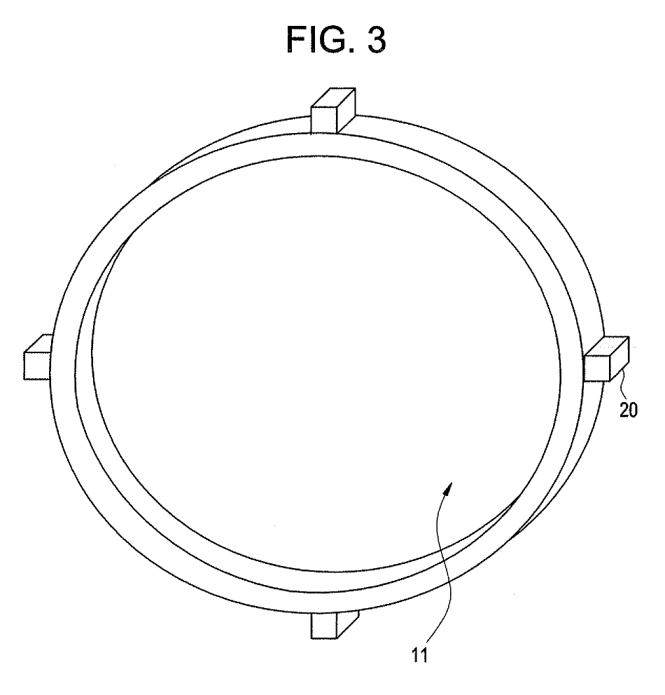

A further embodiment of the present invention is shown in FIG. 3 where a plurality of gauges 20 are distributed radially around the exterior surface of the propagation portion 11. This embodiment allows data to be collected at multiple points at the same downstream location in the device 100. Data such as this can be used to determine if any portion of the propagation portion 11 is experiencing different pressure loads than the others. This embodiment is not limited to that shown in FIG. 2, as it is contemplated that any number of gauges 20 may be used and distributed at any radial orientation. The number and distribution of the gauges 20 are to be determined based on the desired data to be collected or monitored. Further, the radial distribution of downstream gauges 20 may be positioned radially in the same, or different, positions.

In the embodiment shown in FIG. 1 the gauges 20 are shown mounted on an exterior surface of the propagation portion 11. In an alternative embodiment, the gauges 20 are mounted on an exterior surface of the chamber 10. In a further alternative embodiment, gauges 20 are mounted on exterior surfaces of both the chamber 10 and propagation portion 11. The positioning of the gauges 20 is a function of the desired data to be collected or monitored.

The operation of an embodiment of the present invention will now be discussed.

It is known that during operation of a pulse detonation device 100, a high pressure shock wave is generated. As the shock wave travels along the length of the propagation portion 111 and/or the chamber 10, the high pressure shock wave exerts a large amount of force radially out on the walls of the device 100. The forces are relatively high and cause stress and deflection in all components which the pressure wave contacts. Namely, the forces from the pressure wave impart hoop stresses and strain on the walls of the propagation portion 111 and/or the chamber 10. These forces and subsequent stresses peak as the pressure wave passes by.

By placing dynamic strain gauges on an exterior surface of the propagating portion 11 and/or the chamber 10, these stresses and strains can be monitored. Additionally, because the distances between strain gauges 20 are known, and analysis can be conducted regarding the speed at which the pressure wave is traveling. For example, once data is collected the amount of time it takes for the peak strain to travel from a first gauge 20 to a second gauge 20 can be measured. By knowing the distance between the gauges 20, the velocity can be determined by:

$$V = \frac{D}{{t}_{2 ndgage} - {t}_{1 stgage}}$$

where D is the distance between two strain gauges 20, t_{2ndgauge} is the time measured at peak strain at the second gauge 20, and t_{1stgauge} is the time measured at peak strain in the first gauge 20. Additionally, if at least three gauges 20 are used, acceleration or deceleration of the wave can be determined.

As shown in FIG. 2, each of the dynamic strain gauges 20 are coupled to a high frequency AC coupled amplifier 26 to amplify the signals coming from the gauges 20. In an embodiment of the invention all of the strain gauges 20 are coupled to a single amplifier 26, whereas in a further embodiment each gauge 20 is coupled to a separate, discrete amplifier 26. The amplifier 26 (or amplifiers) are coupled to a high frequency data acquisition system 28, which collects and records the data from the amplifiers 26. In an embodiment of the invention, each of the amplifiers 26 are coupled to a single data acquisition system 28. However, the present invention also contemplates having each amplifier 26 coupled to its own system 28.

For the purposes of the present invention each of the amplifiers 26 and the high frequency data acquisition system(s) 28 are of a type commonly known or used. The present invention is not limited in this regarding, and those of ordinary skill in the art are familiar with the types of components and systems which may be used for such an application. For example, the data acquisition system(s) 28 may be a part of, or integral with, a control system used to operate, monitor and/or control the device 100.

The data collected from the present invention may be used for the purposes of testing and/or evaluating pulse detonation devices in a test environment. Further, it is contemplated that the present invention may be used in practical applications where a control system monitors the data from the gauges 20, and controls the operation of the device 100 based on the data. In such a configuration, the system operates in real time, as opposed to those applications where post processing assessments are acceptable (i.e. testing environments).

In an alternative embodiment, the gauges 20 are used in conjunction with additional monitoring devices, such as high frequency pressure transducers 22 and/or ionization probes 24. The transducers 22 and probes 24 can be of any commonly known type, and may be positioned as required, depending on the data to be monitored and acquired. In a further embodiment, additional types of sensors can be used, including light probes, and the like.

While the invention has been described in terms of various specific embodiments, those skilled in the art will recognize that the invention can be practiced with modification within the spirit and scope of the claims.

What is claimed is:

1. A pulse detonation device, comprising:
a detonation chamber in which a pulse detonation is generated;
a propagation portion downstream of said detonation chamber; and
a plurality of mechanical response measurement sensors spaced a predetermined distance from each other and coupled to an exterior surface of at least one of said detonation chamber and propagation portion,
wherein said mechanical response measurement sensors are coupled to at least one data acquisition system such that a signal from said mechanical response measurement sensors is received by said at least one data acquisition system, and
wherein said data acquisition system determines said velocity of a pressure wave within said pulse detonation device using signals from said mechanical response measurement sensors.

2. The pulse detonation device of claim 1, wherein at least one of said mechanical response measurement sensors is either a dynamic strain gauge or accelerometer.

3. The pulse detonation device of claim 1, wherein an amplifier is coupled to at least one of said mechanical response measurement sensors, such that said signal from said at least one mechanical response measurement sensor is amplified prior to being received by said data acquisition system.

4. The pulse detonation device of claim 1, wherein said mechanical response measurement sensors are positioned co-linearly on said external surface.

5. The pulse detonation system of claim 1, wherein at least some of said mechanical response measurement sensors are positioned on said external surface radially with respect to each other.

6. The pulse detonation system of claim 1, further comprising at least one of a pressure transducer and an ionization probe coupled to either said detonation chamber or said propagation portion.

7. A method of determining the wavespeed velocity of a detonation; the method comprising:
initiating a detonation within a detonation chamber of a pulse detonation device;
directing said detonation along a length of said detonation chamber and a propagation portion of said pulse detonation device;
measuring mechanical response on an outer surface of at least one of said detonation chamber and propagation chamber with a plurality of mechanical response measurement sensors; and
determining a velocity of said detonation based on signals from said mechanical response measurement sensors.

8. The method of claim 7, wherein at least one of said mechanical response measurement sensors is either a dynamic strain gauge or accelerometer.

9. The method of claim 7, further comprising amplifying said signals from said mechanical response measurement sensors with an amplifier.

10. The method of claim 7, further comprising using a data acquisition system to determine said velocity.

11. The method of claim 7, wherein all of said mechanical response measurement sensors are distributed co-linearly.

12. The method of claim 7, wherein at least some of said mechanical response measurement sensors are distributed radially with respect to each other.

13. The method of claim 7, wherein each of said mechanical response measurement sensors are distributed a predetermined distance from each other.

14. The method of claim 7, further comprising receiving said signals by amplifiers, such that each of said mechanical response measurement sensors is coupled to a separate one of said amplifiers; and
amplifying said signals.

15. The method of claim 14, further comprising receiving all of said amplified signals by a data acquisition system, and using said high frequency data acquisition system to determine said velocity.
